(19) United States
(12) Patent Application Publication
(10) Pub. No.: US 2006/0074740 A1
(43) Pub. Date: Apr. 6, 2006

(54) Medical facility employee scheduling method using patient acuity information

(75) Inventors: Luis Garcia, Slinger, WI (US); James A. Hennen, Hartford, WI (US); Christopher H. Daute, Grafton, WI (US); Bryan D. Dickerson, Hartford, WI (US)

Correspondence Address: QUARLES & BRADY LLP, 411 E. WISCONSIN AVENUE, SUITE 2040, MILWAUKEE, WI, 53202-4497, US

(73) Assignee: API Software, Inc.

(21) Appl. No.: 10/958,782

(22) Filed: Oct. 5, 2004

(51) Int. Cl. G06F 17/60

(52) U.S. Cl. 705/9

(57) ABSTRACT

An acuity level is assigned to each inpatient at a medical facility and an employee scheduling program uses the patient acuity levels to calculate the number of employees that are required to provide care to the patients. A profile is compiled for each employee specifying that person's patient care capability. The calculated number of employees and the employee profiles are used to schedule employees during the work shifts at the medical facility. At various points in time, the actual amount of time an each employee has worked and the amount of time each employee is scheduled to work in the future are utilized to project whether an employee will work overtime. A supervisor is alerted to projected overtime and may reschedule employees to avoid incurring overtime.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to computer systems for scheduling employees work hours at a medical facility, and more particularly to a computer system which utilizes the number of patients at the medical facility and the acuity of those inpatients in scheduling employees.

2. Description of the Related Art

The number of employees necessary to properly treat medical patients residing in a medical facility, such as a hospital is directly related to the number of such inpatients and the acuteness of their ailment. For a given nursing unit at a hospital more registered nurses, licensed practical nurses, and orderlies are required when more patients are present or when patients have medical conditions that require extensive personal attention or monitoring.

Various systems have been developed for assessing the acuity of a patient. Form example, a numerical scale can be employed to denote the level of acuity in a manner that is directly related to the level of care that the particular patient requires. Therefore the higher the numerical acuity level the more intense amount of nursing care is required.

Medical facilities staff scheduling has manually taken the patient census and general care needs into account when determining how many employees are needed to staff that unit during a work shift. Because manual scheduling is a time consuming process requiring that numerous factors be taken into account, the process did not take the acuity of each individual patient into account and thus did not provide the most economical patient care.

Employee scheduling is further complicated by labor wage and hour laws that restrict the number of hours that certain classes of employees may work during given time periods. When a defined number of hours have been worked during a specified time period, the employee must receive a higher level of compensation for additional hours worked in that period. Failure to abide by these laws can result in the government assessing stiff penalties against the employer.

In addition, union contracts often require that a covered employee be compensated at different rates depending upon the number of hours worked either within a given wage period, a calendar week or a specified number of consecutive days. Failure to abide by those compensation rules may violate the terms of the contract and result in the assessment of penalties. Many employers also have developed their own rules which provide additional compensation to employees in certain circumstances based on the number of hours worked.

An employee's work schedule at a medical facility can vary from day to day and week to week. In a hospital for example, one employee may be assigned to work eight hours during each of five consecutive days, while other employees work three consecutive 12 hour days and then not have to report to work for the next four consecutive days. Other personnel are part-time, in which case they work less than an eight hour day. Some employees are not assigned to a specific department, but float wherever workers are needed on a given day and these floating employees often work varying amounts of time according to staffing requirements at the time. During an unanticipated situation, such as an emergency, an employee may be called in to work unscheduled hours. Therefore it is often difficult when scheduling employees to know whether a particular person will receive overtime pay for a given work period.

Computerized employee scheduling programs have been developed to assign workers to different work shifts during a future wage period. The resultant schedule is printed and provided to each employee prior to commencement of that wage period, thus informing the employee when to report to for work and the duration of each work period. However, heretofore such employee scheduling programs did not take patient population and acuity into account to project employee overtime and operating costs. Nor did such programs warn the scheduling personnel when employees being scheduled would qualify for overtime pay.

### SUMMARY OF THE INVENTION

A computerized method for scheduling employees at a medical facility assigns acuity levels to patients. From the acuity levels, a number of employees that are required to provide care to the patients is determined. For example, the acuity level of each patient is used to derive amounts of time that each of several categories of employee are estimated to devote to the patient during each work shift. From the total amount of time for each category of employee the number of such employees is calculated.

The employees are scheduled to work at the medical facility, so that the calculated number of employees are provided. In the preferred embodiment, a profile is compiled-for each employee which specifies that person's medical care capabilities and qualifications. The profile information is used to fill the care requirements during each work shift.

Another aspect of the present employee scheduling method involves projecting whether scheduling a particular employee will entitle that person to extra compensation for working overtime. Information indicating an actual amount of time each employee has worked during completed work periods is recorded in the computer system of the medical facility. The amount of time that each employee is scheduled to work in the future and the actual amount of time each employee has worked is utilized to project whether any of the employees are anticipated to work overtime in the future.

A further aspect of this method entails notifying supervisory personnel when an employee is projected to work overtime and afford the supervisory personnel an opportunity to revise the work schedule to avoid incurring the overtime.

### BRIEF DESCRIPTION OF THE DRAWINGS

FIG. 1 is a schematic diagram of a hospital computer system which stores patient records, as well as employee work schedules and attendance data;

FIG. 2 is a flowchart of a process for entering patient information into the hospital computer system;

FIG. 3 represents data structure of computer file containing patient profiles;

FIG. 4 is a flow chart of the computerized process for scheduling employees for the work shifts;

FIG. 5 illustrates a table of estimated number of hours required from different classes of employees at the various nursing units during each work shift;

FIG. 6 depicts data in a file containing work schedules for employees;

FIG. 7 illustrates an entry in the time and attendance data file;

FIG. 8 is a flow chart of the method according to the present invention, which projects when an employee will work overtime;

FIG. 9 shows a data structure used to determine when an overtime condition is anticipated to occur; and

FIG. 10 represents a user display produced from data generated by the overtime projection method which alerts supervisory personnel to projected overtime.

### DETAILED DESCRIPTION OF THE INVENTION

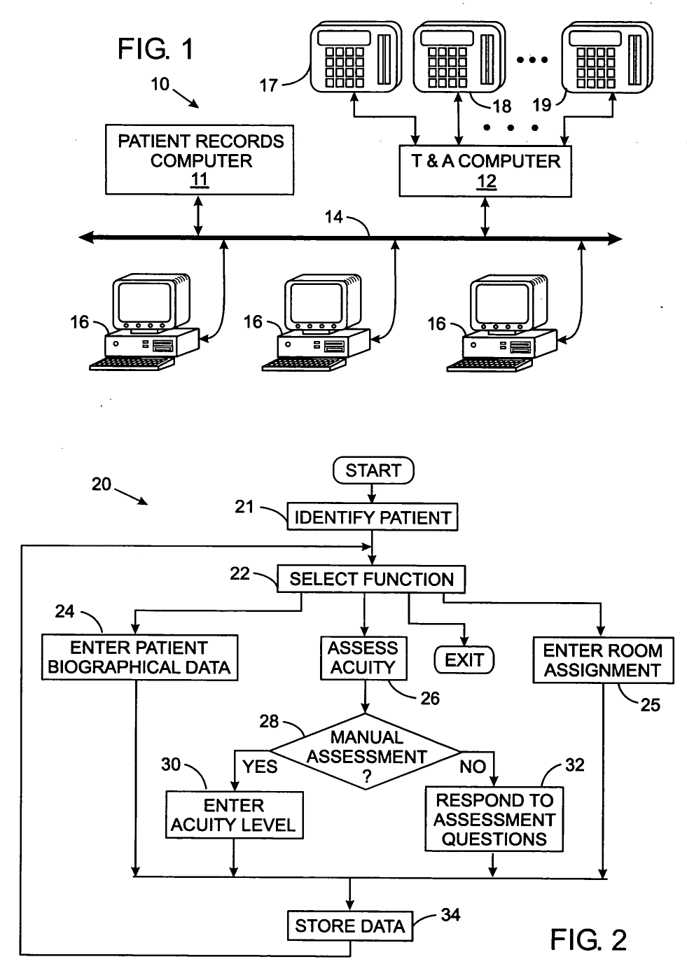

FIG. 1 illustrates a computer system 10 of a hospital. Although the present invention is being described in the context of a hospital, the inventive concepts can be applied to other patient care facilities, such as nursing homes and extended care facilities for example. The computer system 10 includes one computer 11 that processes and stores patient records and a time and attendance (T&A) computer 12 which executes software programs that schedule work periods for employees and then records the actual amounts of time each employee works. The patient records computer 11 and the time and attendance computer 12 are connected to a standard local area network (LAN) 14 of a type commonly found in work places. A plurality of personal computers 16 are connected to the local area network 14 to exchange data and commands with the computers 11 and 12.

For processing employee time and attendance data, a plurality of badge readers 17, 18 and 19, through which employees indicate when they start and end periods of work, are located throughout the business and are connected to the local area network 14. The badge readers 17-19 can take any of a number of commercially available forms. For example, each employee is issued an identification badge that has a magnetic strip which encodes a unique employee number and the magnetic strip is read when the employee swipes the identification badge through a slot of a badge reader 17-19. Each badge reader also has a keypad by which an employee number or other information can be entered into the time and attendance computer 12. A display screen on each card reader 17-19 presents information to the employee.

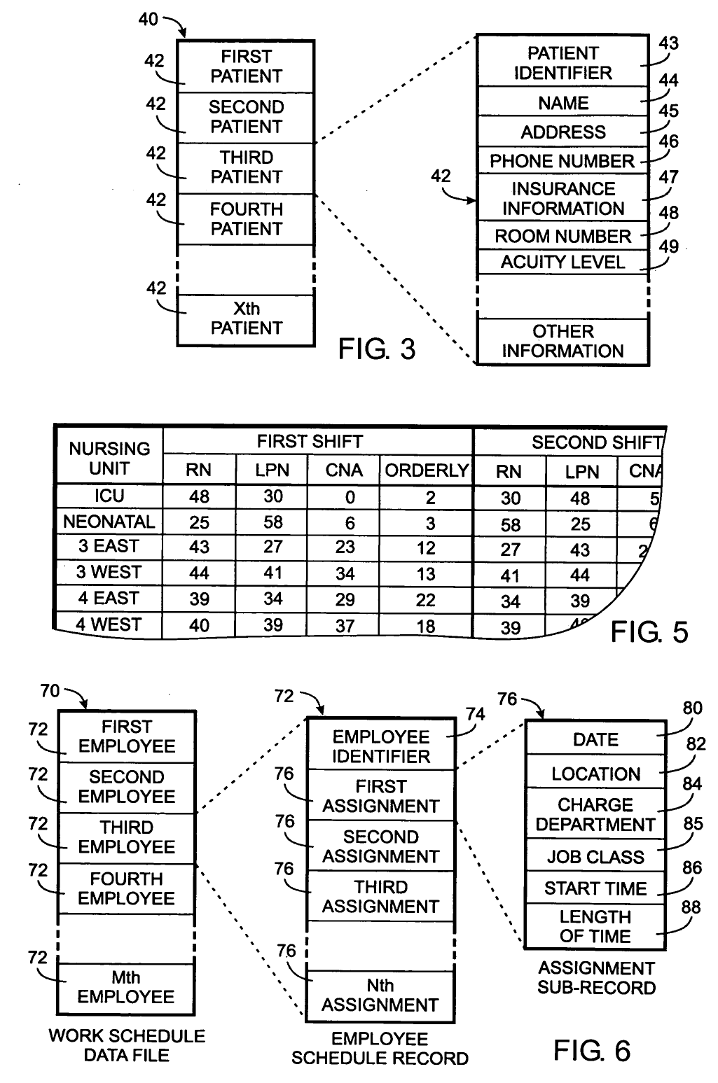

When a patient enters the hospital, an admissions office employee inputs information into the patient records computer 1 1 via one of the personal computers 16. For that process, the personal computer 16 executes a patient data software program 20 represented by the flow chart in FIG. 2. The admissions employee first identifies the patient at step 21 and for a new patient, selects at step 22 a menu choice to enter biographical information about the patient which results in the program branching to step 24. At this time, a data entry form is displayed on the personal computer screen in which information about the patient is entered. That data entry creates a profile 42 for that patient within a patient file 40, as depicted graphically in FIG. 3. The profile 42 for a given patient includes fields for a unique number or other identifier 43 of that individual as well as the person's name 44, home address 45 and home phone number 46. Insurance information also is stored in field 47 of the patient profile 42.

Data related to the patient's stay in the hospital is inputted at the admissions office or subsequently by other hospital personnel who have authority to access the patient data software program 20. Such additional data identifies the room to which the patient is assigned which is entered into record field 48 at step 25. An acuity level corresponding to the patient's medical condition is stored in the patient's record field 49. The acuity level also relates to the intensity of nursing care required for the patient and will be used to estimate of the amount of nursing time that this patient will require during each work shift. The patient profile 42 may contain other types of information as desired by the medical facility.

The designation of the patient acuity level is of particular significance for scheduling employees at the hospital as it relates to the amount of nursing attention required by the patient. The acuity level typically is determined by medical personnel after the admission process and is changed as the patient's condition improves or deteriorates. In order to enter or change an acuity level, the patient data software program 20 branches to step 28 where the user indicates whether a manually determined level will be entered or whether the program is to determine the acuity level. If the user already has determined the acuity level, the program branches to step 30 where that level is entered into the personal computer 16. Otherwise the program goes to step 32 at which a series of questions related to the patient's status is presented to the user. These questions include whether the patient is ambulatory, is on a ventilator, can use a toilet, is able to feed himself, and the frequency that nurse observations or vital signs must be taken. Inquiries also are made regarding the frequency of medication and other treatments. Based on the responses to the series of questions, the software program determines the acuity level for the patient and the data is stored at step 34.

That employee scheduling is performed by supervisory personnel who use the personal computers 16 to create employee schedules via the time and attendance computer 12 and subsequently check and alter the schedules as necessary. For example, the basic scheduling of core employees can be performed a few weeks in advance and then checked on a daily basis to determine whether the patient population requires that additional people be scheduled. In addition, when a previously scheduled employee calls in sick, a supervisor changes the work schedule to substitute another employee for the absent worker. Supervisors also utilize the personal computers 16 to monitor attendance and the actual hours worked by the employees. As will be described, such monitoring identifies when an employee is anticipated to work overtime and allows a supervisor to alter the work schedule to avoid unnecessary or unwanted overtime.

The personal computers 16 enable appropriate personnel to access a standard employee staffing and scheduling program, such as the ActiveStaffer ) Series available from API Software, Inc. of Hartford, Wis., U.S.A. This program is executed on the time and attendance computer 12 and provides a listing of all the employees available for assignment to a given department and each employee's work preferences, such as a work shift, vacation schedule, and the like. This enables the employees to be assigned to specific work shifts and to an amount of time during each shift, either automatically by the computer program or manually by a supervisor. Some employees may work eight hour shifts, while others have twelve hour shifts. The schedule for each employee is stored in a work schedule data file within a storage device of the time and attendance computer 12.

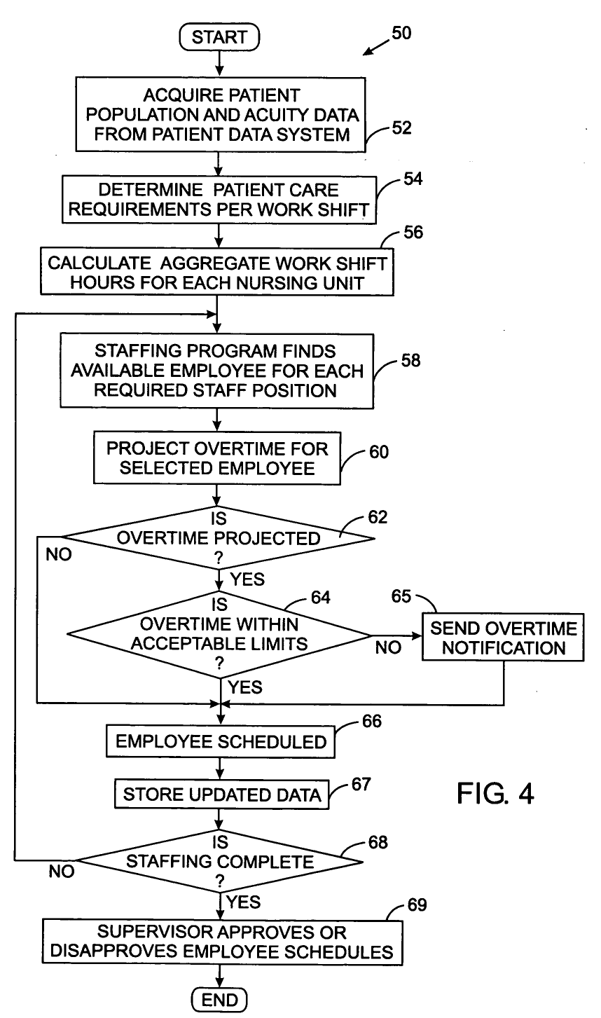

With reference to FIG. 4, the employee staffing and scheduling program 50 commences by determining the staffing requirements in the different departments of the hospital. Of particular relevance is the staffing of nursing unit which is based on the number of patients and their acuity levels. Thus at step 52, the program acquires the patient population and acuity data from the files in the patient records computer 11. That data then is utilized at step 54 to estimate the amounts of nursing time each patient requires. A particular patient can be attended to by several different types of medical personnel, including registered nurses (RN), licensed practical nurses (LPN), certified nursing assistants (CNA) and orderlies. The amount of time a patient requires also varies throughout the day, for example patients require little nursing attention while asleep, therefore less staff is required during the night work shift in regular nursing units. The program takes these factors into account when calculating the hours that are required during each work shift for each class of employee. For example, a set of rules is stored in the computer that specifies the nursing care requirements during each work shift for each acuity level. The nursing care requirements take into account not only the amount of patient contact likely to be required, such as administering medications, changing bandages and bed linens and the like, but also on the amount of record keeping and other administrative activities that also may vary as a function of patient acuity.

Then at step 56, the aggregate number of hours of the different types of nursing care during each work shift is calculated for each nursing unit of the hospital. The patient room assignment is used to determine the associated nursing unit. The result of the processing at step 56 is a table of data as depicted in FIG. 5 which is stored in the memory of the time and attendance computer 12. This table specifies the amount that each class of employee is estimated to devote during each work shift to the care of the patients in each nursing unit.

The employee staffing and scheduling program 50 then advances to step 58 where the computer file of hospital employee profiles is used to fill the staffing needs of each nursing unit. The employee profiles indicate whether each employee is available to work during the time period being staffed, their job category (e.g. RN, LPN, etc), any special certifications or care capabilities, such as Intensive Care Unit (ICU) training, and other scheduling factors. Certain employees may be designated as being only assignable or preferred for assignment to a particular nursing unit. For example, the emergency room requires nurses with a different set of skills than floor nurses and certain nurses may only work in the emergency room. Using the employee profile data, the employee staffing and scheduling program 50 assigns the personnel to the various nursing units, as well as other departments of the hospital.

The employee scheduling process creates a work schedule data file in the memory of the time and attendance computer 12. With reference to FIG. 6, the work schedule data file 70 contains a plurality of records 72, each storing the work schedule information for one employee. Employees may be scheduled in advance for one or more weekly periods. Each employee record 72 has a field 74 which contains an identifier, such as a social security number or a unique employee number assigned by the employer. The remainder of the employee schedule record 72 contains a plurality of work assignment sub-records 76, the number of with depends upon how many work periods the employee will work during the schedule period. Each work assignment sub-record 76 has a first field 80 which stores the date of the assignment and a second field 82 specifying the location where the employee is to work. In the case of a hospital, for example, a nurse may be assigned to different areas on different days. A third field 84 contains an identification of the department which is to be charged for the employee's time worked on this assignment. A fourth field 85 holds information specifying the job class associated with this assignment. A given nurse may work as a regular registered nurse (RN) on some days, and as head registered nurse or another capacity on other days. The job class also identifies the wage scale that the employee is to receive for this assignment. The fifth and sixth fields 86 and 88 in the assignment data define the start time of the assignment and its duration. Preferably the duration is specified by the length of the work period (e.g. a number of hours), but alternatively the duration could be indicated by storing the scheduled end time of the work period.

During the scheduling process, data from the work schedule data file 70 is displayed on the screen of the respective personal computer 16 in a spreadsheet format with each line corresponding to a different employee and columns provided for each work day. In the course of displaying the information, the scheduler software also may acquire data from the main employee file in order to display the that person's job title, seniority, and other information.

The time and attendance (T&A) computer 12 in FIG. 1 also executes a time and attendance software program, such as the Payrollmation® Series available from Automating Peripherals, Inc. of Hartford, Wis., U.S.A. This type of program records the arrival and departure times of the employees within the hospital. As noted previously, each hourly employee swipes their magnetically encoded employee badge through one of the readers 17-19 upon entering and leaving the work place. This provides an identification of the employee to the time and attendance computer 12 which logs that identification along with the date and time of day at which the entry occurred. This implements an electronic time clock which records the arrival and departure of the employees in a time and attendance data file 90 stored within the host computer.

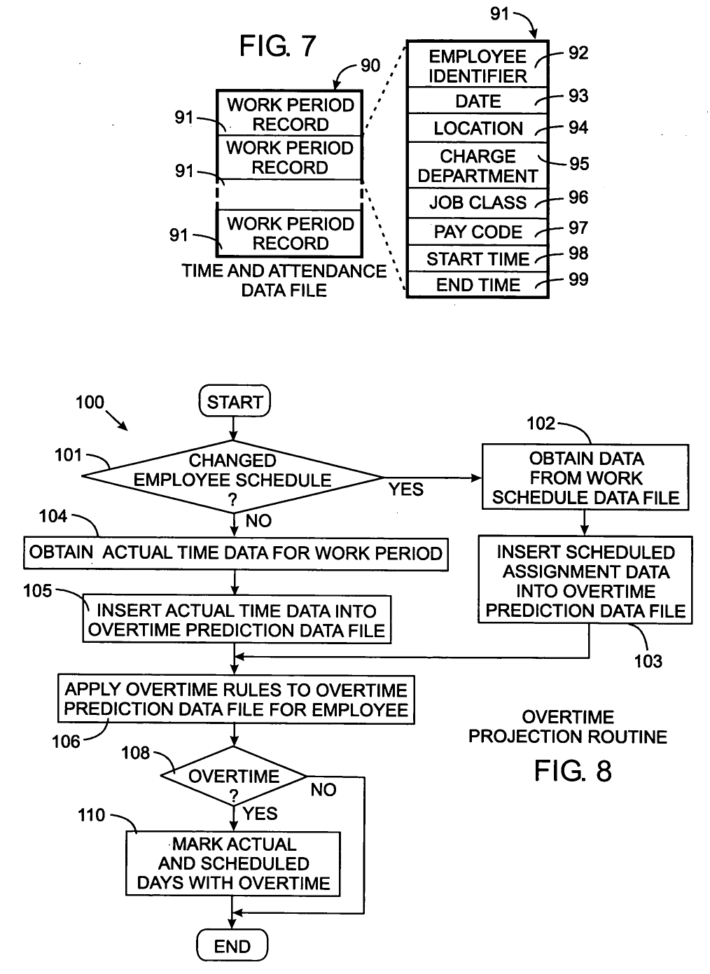

With reference to FIG. 7, the time and attendance data file 90 stores a plurality of records 91 each containing information related to a period actually worked by an employee. Specifically each work period record 91 has a first field 92 that contains the identifier for the associated employee and a second field 93 stores the date on which the work was carried out. Four fields 94, 95, 96, and 97 contain labor distribution information obtained from the corresponding assignment sub-record 76 in the work schedule data file 70. Field 94 identifies the location at which the work was performed, and field 95 specifies the department that is to be charged for this work. Another field 96 provides the job class for this work period, while field 97 stores the pay code that is used to determine the wage for this assignment. In the event that this particular work period relates to an unscheduled assignment, for example an emergency for which the employee was called into work, the labor distribution information in fields 94-54 are created from manual entries made either by the employee into one of the badge readers 17-19, or by a supervisor via one of the personal computers 16.

When an employee swipes an identification badge through a reader 17-19, the time and attendance software scans the existing records in the time and attendance data file 90 for any open work period records 91 for that employee, i.e. record without data in the end time field 99. If the employee is entering the workplace an open work period record 91 will not be found. In that case, the time and attendance software creates a new work period record 91 for that employee using the employee number read from the identification badge and by gathering data from the corresponding assignment in the work schedule data file 70. The current date and time of day are entered into the corresponding fields of that new record. The work period records 91 are stored chronologically according to the time that an employee arrives at work. Subsequently when a payroll is to be generated the time and attendance data are reorganized into another data file organized by employee number.

The next time the employee swipes the identification badge through a reader 17-19 upon leaving the hospital, the time and attendance program finds the open work record created previously when the employee entered the hospital. The current time of day is entered in the end time field 99 of that open record, thereby indicating the end of that work period. The system recognizes when the person clocks into work one day and clocks out of work the next day, because the end time is appears to be earlier than the start time. For example, if the start time is 11:00 p.m. and the end time is 05:00 a.m., the system will recognize that the employee clocked out at 05:00 a.m. the next day and will compute the hours worked accordingly.

Returning again to the operation of the employee staffing and scheduling program 50 in FIG. 4, a review of the employee schedules is conducted to ascertain whether any of them will incur overtime and thus be entitled to a higher level of compensation. In that event, the scheduling supervisor is notified and afforded an opportunity to approve or disapprove the overtime. At step 60, an overtime projection subroutine 100 in FIG. 8 is called which analyzes the time actually worked and the time scheduled for the future for each employee and identifies on which day or days the overtime will occur.

The overtime projection subroutine 100 is run upon the creation or revision of the work schedule data file 70 or upon an employee clocking out of work resulting in new actual time data being generated. When this subroutine commences at step 101, a determination is made whether the execution was triggered by a change in the employee schedule in which event the execution branches to step 102. Now, the schedule changes are read from the work schedule data file 70 and inserted into the overtime projection data file 120 at step 103. For example, the overtime projection data file contains data for a three-week period, consisting of the current week and two weeks into the future, however periods of other lengths can be used. Thus the newly scheduled days are added at the end of the overtime projection data file 120. The execution then advances to step 106 to provide indications of overtime which has been scheduled for the employees.

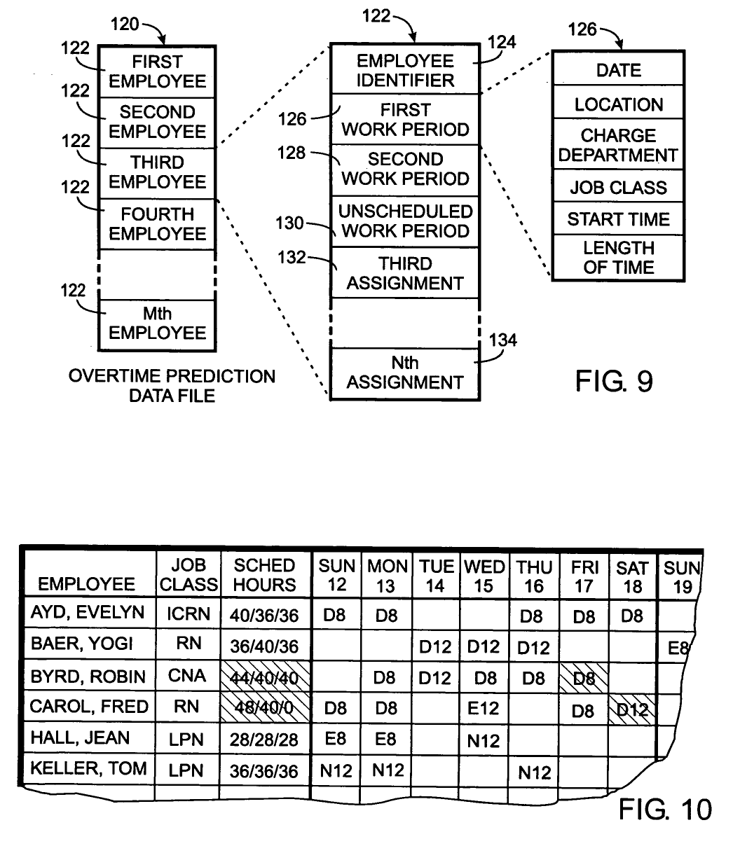

If the overtime projection subroutine 100 is run in response to an employee clocking out of work, the execution branches from step 101 to step 104 at which the actual time data for the completed work period record 91 is copied from the time and attendance data file 90 into the overtime projection data file 120 at step 105 as a work period record 91 (FIG. 9). The actual amount of time worked also is stored in the new work period record. A record containing actual work period data is distinguished from a record for a scheduled work period by a data flag or other means.

Then the overtime projection data file 120 is searched for scheduled work assignments which should have terminated before the present time of day. This is accomplished by adding the length of time for the scheduled assignment to its start time and, if the resultant time of day has past, that assignment record is deleted from the overtime projection data file 120. Any assignments yet to be completed are left in this data file. As a result, records 126 and 128 in the exemplary overtime projection data file 120 in FIG. 9 correspond to completed scheduled work assignments and record 130 contains data for an unscheduled work period which the employee performed. The third and subsequent work assignments have not yet occurred, and thus remain as assignment records 132-134.

Once the overtime projection data file 120 has been updated, the program execution advances to step 106 where the overtime rules applicable to each employee are applied to the records 122 in the overtime projection data file. For example, one of these rules may be whether the employee has worked more than forty hours in a single calendar week. Other rules may be dictated by a union contract or by voluntary rules adopted by the particular employer. For example, overtime may also apply whenever the employee works more than forty hours in seven consecutive days, even though that seven day period does not correspond to a calendar week. The overtime rules are stored in a separate file in the time and attendance computer 12. In applying these rules to the overtime projection data file 120, the overtime projection subroutine 100 looks not only at the actual hours of completed work, as indicated by the work period data (records 126-130), but also looks ahead in time at the remaining scheduled work assignments (records 132-134). In determining whether overtime will occur, the overtime projection subroutine 100 assumes that the remaining scheduled work assignments will be performed. If at step 108 the overtime projection subroutine 100 finds that a particular employee will not incur overtime, even if all of the remaining scheduled work assignments are performed, execution of the subroutine terminates. However, when a likelihood of overtime occurring is found at step 108, the program advances to step 110 where the assignments, which will produce overtime hours, are marked with a flag. Then program execution returns to step 62 of the main employee staffing and scheduling program 50.

Referring again to FIG. 4, if overtime is not projected for the employee being scheduled the execution branches to step 66 at which the schedule is finalized before being stored at step 67. However, if overtime is found projected at step 62, the program branches to step 64 where a determination is made whether that overtime complies with guidelines established by the employer. For example, employers recognize that a certain level of overtime is to be expected because it may not be cost effective to eliminate all overtime. In order to eliminate overtime entirely, additional employees would have to be hired and when the salary and benefit costs for those additional employees are taken into account, it may cost the employer more to have additional employees than to incur a certain amount of overtime. The specific overtime acceptability rules typically vary for different job codes, the department of the hospital, and other factors. For example, the employer may accept up to four hours of overtime for a particular job code. If the projected overtime is found to be within the acceptable limits at step 64, the schedule is finalized at step 66 and then stored at step 67.

However, if at step 64 the projected overtime is outside the hospital guidelines, the program execution branches to step 65 where an overtime notification message is sent to the scheduling supervisor. For example, an email form message can be transmitted to a person specified in the employee staffing and scheduling program 50. That message informs the recipient that this employee has been scheduled with a typically unacceptable amount of overtime. The employee then is scheduled and the schedule stored at steps 66 and 67. Alternatively, the system may be configured not to schedule an employee who will thereby exceed the predefined overtime limits, in which case an overtime notification message is not sent and another employee is scheduled instead.

Next at step 68, a determination is made whether the employee scheduling is finished for all the departments. If not the execution returns to step 58 to schedule another employee.

When the scheduling for all the departments has completed, the program awaits for the supervisor to review the proposed schedules at step 69 and approve the scheduled overtime. The supervisor uses one of the personal computers 16 to access the contents of the overtime projection data file 120 for the affected employees. A user interface program produces a spreadsheet-like display depicted in FIG. 10. That display has columns for the employee names, job classes, and the total number of hours scheduled for each employee during the three week scheduling period. Only one week of data is shown drawing with additional columns extending to the right for all the days of that three week period. Each row of the table relates to a different employee. Each cell of the display indicates the shift and the number of hours to be or which have been worked by that employee on that day. For example, D8 designates eight hours on the daytime shift. The letter E denotes the evening shift, while the letter N indicates the night shift.

Assume that today is Wednesday the 15^{th} of the month, the display contains actual data for Sunday the 12th through Tuesday the 14^{th} and contains scheduled assignment data for the remaining four days of the week. Note for example that Robin Byrd was scheduled to work forty hours this week, thus having been scheduled to work eight hours during the daytime shift on Tuesday the 14^{th}. However, the display indicates that this employee actually worked twelve hours (D12) during that daytime shift. As a result, if this Ms Byrd works the remaining scheduled eight hours shifts on Wednesday, Thursday and Friday, some of the time on Friday will become overtime. This event is highlighted by changing the background color of Robin Byrd's display cell for Friday the 17^{th} to draw the viewer's attention to this cell. In addition, the scheduled hours cell also is highlighted. Note that Fred Carol was scheduled to work 48 hours this week (the 48 in the entry 48/40/0), thus being scheduled for four hours of overtime. This overtime event also is indicated by this employee's highlighted display cell for Saturday the 18^{th}.

Upon viewing the displayed information, a supervisor has the option to take several courses of action. The four hours of unscheduled overtime for Robin Byrd may be accepted and that employee allowed to work the full eight hour shift on Friday the 17^{th}. Alternatively, the schedule for Robin Byrd may be changed so that she only works four hours on that Friday, thus working a total of forty hours for the week and not incurring any overtime. However, shortening the scheduled shift on Friday for Robin Byrd may require assignment another employee to work those eliminated four hours, thus requiring the supervisor to rearrange other worker's schedule. For example, there may be personnel in other departments which are overstaffed and have under utilized employees who are available to work additional time without incurring overtime compensation. In which case, employees from those departments could be assigned to fill in for the four hours that Robin Byrd will not be working.

If the supervisor elects to change the scheduled shift on Friday for Robin Byrd, the supervisor exits the program which displays the overtime projections and starts the scheduling program. That latter program is used enter the desired changes into the work schedule data file 70. Upon completing those changes, the overtime projection routine 60 is called automatically to revise the overtime projection data file 120, as described previously.

Alternatively, the overtime projection subroutine 100 can be interfaced to the employee staffing and scheduling program to automatically reschedule the employee who is projected to have overtime. As noted previously, computer programs, such as the ActiveStaffer® Series software, are capable of automatically assigning workers to positions needing to be staffed. This software also employs the overtime rules so that overtime occurrences are minimized and allowed only in specific situations defined by the employer. Therefore, when a given employee is projected to work unscheduled overtime, the overtime projection subroutine 100 sends a message to the employee staffing and scheduling program identifying the employee and when the overtime is projected to occur. The employee staffing and scheduling program responds to this message by running its scheduling procedure, which reduces the time assigned in the future to the identified employee and fills the vacated work period with another employee who can work without qualifying for overtime compensation. Then, the overtime projection subroutine 100 is called to revise the overtime projection data file 120.

The foregoing description was primarily directed to preferred embodiments of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

What is claimed is:

1. A computerized method for scheduling employees at a medical facility, said method comprising:
assigning acuity levels to patients at the medical facility;
determining, in response to the acuity levels of the patients, a number of employees that are required to provide care to the patients; and
scheduling a plurality of employees at the medical facility, in response to the number of employees that are required to provide care to the patients, thereby producing an employee work schedule.

2. The method as recited in claim 1 wherein assigning acuity levels to patients comprises:
presenting a person at the medical facility with a plurality of inquiries related to care requirements of a patient;
receiving answers to the plurality of inquiries; and
specifying an acuity level for the patient in response to the answers.

3. The method as recited in claim 1 wherein determining a number of employees comprises determining a number of employees required at each of a plurality of nursing units in the medical facility based on patient care requirements in each nursing unit.

4. The method as recited in claim 1 wherein determining a number of employees that are required comprises determining a number of employees required during each of a plurality of work shifts.

5. The method as recited in claim 1 wherein determining a number of employees that are required comprises determining a number of employees in each of a plurality of employee categories that are required to provide care to the patients.

6. A method as defined in claim 1 wherein each employee has a predetermined patient care capability; and wherein the method further comprises scheduling employees based on patient care capability.

7. The method as recited in claim 1 wherein the employee work schedule defines a scheduled amount of time for each of the plurality of employees, and further comprising:
recording information indicating an actual amount of time each of the plurality of employees worked during completed work periods; and
at a given point in time, employing the scheduled amount of time for work periods which terminate in the future and the actual amount of time to project whether any of the plurality of employees will work overtime in the future.

8. The method as recited in claim 7 further comprising notifying a person at the medical facility when an employee is projected to work overtime.

9. The method as recited in claim 1 further comprising enabling a person at the medical facility to alter the employee work schedule.

10. A computer program readable by a computer and encoding instructions executing the method defined in claim 9.

11. A computer program product readable by a computer and encoding instructions executing the method defined in claim 1.

12. A computerized method for scheduling employees at a medical facility, said method comprising:
compiling a plurality of patient profiles, each associated with a different patient and containing an acuity level for the associated patient;
in response to the acuity levels of the patients, determining a number of employees that are required to provide care to the patients;
compiling a plurality of employee profiles, each associated with a different employee and specifying a patient care capability of the associated employee,
employing the number of employees that are required and the plurality of employee profiles to schedule employees at the medical facility, thereby producing an employee work schedule defining a scheduled amount of time for each of a plurality of employees;
recording information indicating an actual amount of time each of the plurality of employees worked during completed work periods; and
employing the scheduled amount of time for work periods which terminate in the future and the actual amount of time to project whether any of the plurality of employees will work overtime in the future.

13. The method as recited in claim 12 further comprising notifying a person at the medical facility when an employee is projected to work overtime.

14. The method as recited in claim 13 further comprising enabling the person at the medical facility to alter the employee work schedule.

15. The method as recited in claim 12 further comprising enabling a person at the medical facility to alter the employee work schedule.

16. The method as recited in claim 12 wherein compiling a plurality of patient profiles comprises:
presenting a person at the medical facility with a plurality of inquiries regarding care requirements of a patient;
receiving answers to the plurality of inquiries; and
specifying an acuity level for the patient in response to the answers.

17. The method as recited in claim 12 wherein determining a number of employees comprises determining a number of employees required at each of a plurality of nursing units in the medical facility.

18. The method as recited in claim 12 wherein determining a number of employees comprises determining a number of employees required during each of a plurality of work shifts.

19. The method as recited in claim 12 wherein determining a number of employees comprises determining a number of employees in each of a plurality of employee categories that are required to provide care to the patients.

20. A method as defined in claim 12 wherein each employee profile specifies a patient care capability; and wherein the method further comprises scheduling employees based on patient care capability.
